(19) United States
(12) Patent Application Publication
(10) Pub. No.: US 2018/0192008 A1
(43) Pub. Date: Jul. 5, 2018

(54) INTELLIGENT MONITORING SYSTEM

(71) Applicant: Shenzhen Sunlight Security Electronics Co. Ltd., Shenzhen (CN)

(72) Inventor: ZHICHENG ZHOU, Shenzhen (CN)

(21) Appl. No.: 15/396,437

(22) Filed: Dec. 31, 2016

(51) Int. Cl. H04N 7/18; G07C 9/00; H04N 5/225

(52) U.S. Cl. CPC H04N 7/185; G07C 2009/00928; H04N 5/2252; G07C 9/00309

(57) ABSTRACT

An intelligent monitoring system includes an intelligent monitoring device, a mobile terminal, and a garage door device. The intelligent monitoring device includes a first communicating module and an image capturing module for collecting an multi-media information and transmitting it to the first communicating module. The mobile terminal includes a displaying module, a second communicating module receiving and sending the multi-media information to the displaying module, and a transmitting module. A user determines whether the garage door is in the open state or the closing state, and sends an instruction information via the transmitting module. The garage door device includes a third communicating module, a controlling module, and a driving module, the third communicating module receiving and sending the instruction information to the controlling module, the controlling module sending a controlling signal to the driving module, the driving module opens the garage door or to closes the garage door.

### BACKGROUND

### Technical Field

The present disclosure generally relates to intelligent monitoring systems, and more particularly to an intelligent monitoring system with a mobile terminal.

### Description of Related Art

When a vehicle needs to be driven into or out of a garage, a driver must get off and open a door of the garage. It is inconvenient for the driver to drive the vehicle into or out of the garage when raining or hot sun.

Accordingly, a need exists in the industry to overcome the described problems.

### SUMMARY

The disclosure relates to an intelligent monitoring system.

In one aspect, an intelligent monitoring system includes an intelligent monitoring device, a mobile terminal, and a garage door device. The intelligent monitoring device includes an image capturing module and a first communicating module, wherein the image capturing module is used for collecting a multi-media information and transmitting the multi-media information to the first communicating module, and wherein the multi-media information includes a first multi-media information when a garage door is in an open state and a second multi-media information when the garage door is in a closing state. The mobile terminal includes a second communicating module, a displaying module, and a transmitting module, the second communicating module receiving the multi-media information from the first communicating module and sending the multi-media information to the displaying module, wherein a user determines whether the garage door is in the open state or the closing state according to the multi-media information displayed by the displaying module, and sends an instruction information via the transmitting module. The garage door device includes a third communicating module, a controlling module and a driving module, the third communicating module receiving the instruction information and sending the instruction information to the controlling module, the controlling module distinguishing the instruction information and sending a controlling signal to the driving module, the driving module driving a motor connected to the garage door according to the controlling signal to open the garage door or close the garage door.

Wherein the intelligent monitoring device includes a housing including a first cover defining a first hole, a first PCB mounted to the housing and a second PCB connected to the first PCB. The first PCB defines a second hole corresponding to the first hole. The second PCB includes the image capturing module, and the image capturing module extends through the first hole and the second hole.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an intelligent monitoring system in accordance with the present invention;

FIG. 2 is an assembled perspective view of an intelligent monitoring device in accordance with the present invention;

FIG. 3 is an explode view of the intelligent monitoring device of FIG. 2;

FIG. 4 is a perspective view of a second cover of the intelligent monitoring device of FIG. 2;

FIG. 5 is an assembled perspective view of a supporting device in accordance with the present invention;

FIG. 6 is an explode view of the supporting device of FIG. 5; and

FIG. 7 is a perspective view of a fixing member of the supporting device of FIG. 5.

### DETAILED DESCRIPTION

The disclosure is illustrated by way of example and not by way of limitation in the figures of the accompanying drawings, in which like reference numerals indicate similar elements. The embodiments described in accordance with the drawings are only examples, and thus the claimed invention is not limited thereto.

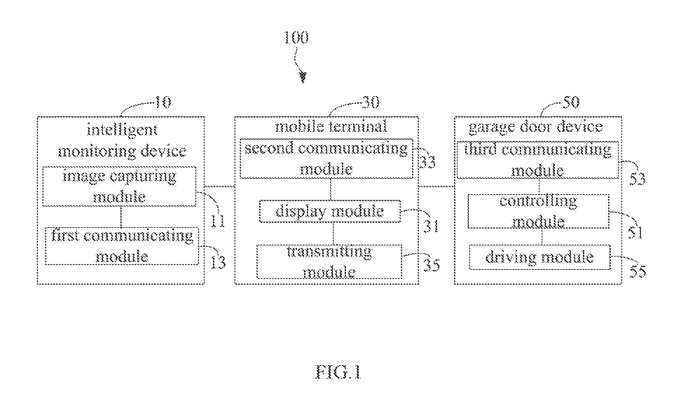

Referring to FIG. 1, an intelligent monitoring system 100 of the present invention includes an intelligent monitoring device 10, a mobile terminal 30, and a garage door device 50. The intelligent monitoring system 100 is mounted on a wall or a fixing device opposite to the garage door device 50.

The intelligent monitoring device 10 includes an image capturing module 11 and a first communicating module 13. The image capturing module 11 is used for collecting a multi-media information of a garage door and transmitting the multi-media information to the first communicating module 13. The multi-media information comprises a first multi-media information when the garage door is in an open state and a second multi-media information when the garage door is in a closing state.

In one embodiment, the multi-media information includes an image information and a video information.

The mobile terminal 30 includes a second communicating module 33, a displaying module 31, and a transmitting module 35. The second communicating module 33 receives the multi-media information from the first communicating module 13 and sending the multi-media information to the displaying module 31. A user determines whether the garage door is in the open state or the closing state according to the multi-media information displayed by the displaying module 31, and sends an instruction information via the transmitting module 35.

In one embodiment, the instruction information includes a first instruction information when the garage door is in the open state and a second instruction information when the garage door is in the closing state.

In one embodiment, the mobile terminal 30 is a mobile phone, a tablet, or a drive recorder.

The garage door device 50 includes a third communicating module 53, a controlling module 51, and a driving module 55. The third communicating module 53 receives the instruction information and sending the instruction information to the controlling module 51. The controlling module 51 distinguishes the instruction information and sending a controlling signal to the driving module 55. The driving module 55 drives a motor connected to the garage door according to the controlling signal to open the garage door or close the garage door.

In one embodiment, the controlling signal includes a first controlling signal when the garage door is in the open state and a second controlling signal when the garage door is in the closing state.

In use, when the garage door needs to be open, i.e., the garage door is in the closing state, the user transmits the second instruction information to the garage door device 50 via the mobile terminal 30, the garage door device 50 drives the motor to drive the garage door to open; when the garage door needs to be closed, i.e., the garage door is in the open state, the user transmits the first instruction information to the garage door device 50 via the mobile terminal 30, the garage door device 50 drives the motor to drive the garage door to close. That is to say, the mobile terminal 30 can control the garage door opening or closing, thereby realizing remote controlling the garage door and convenient to enter and leave the garage.

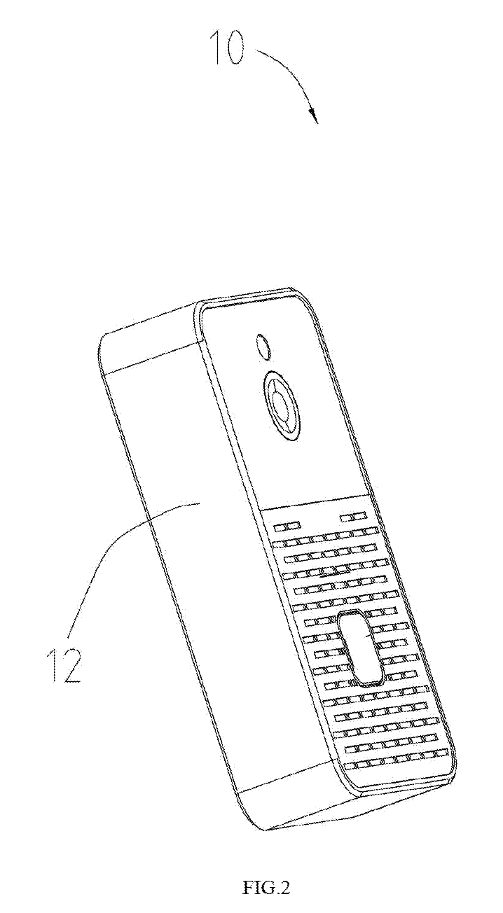

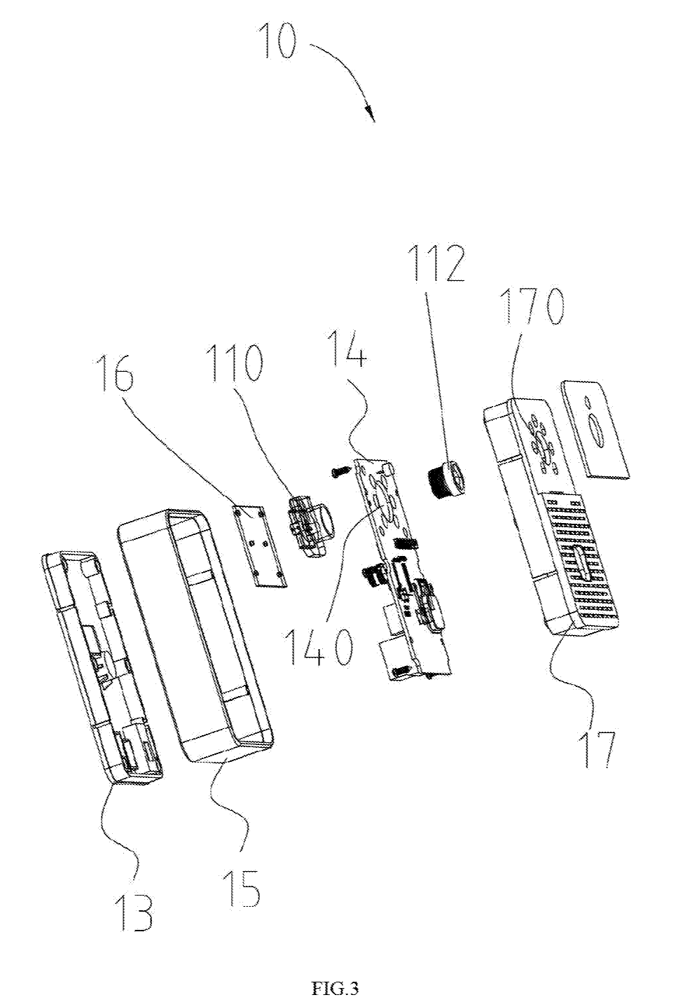

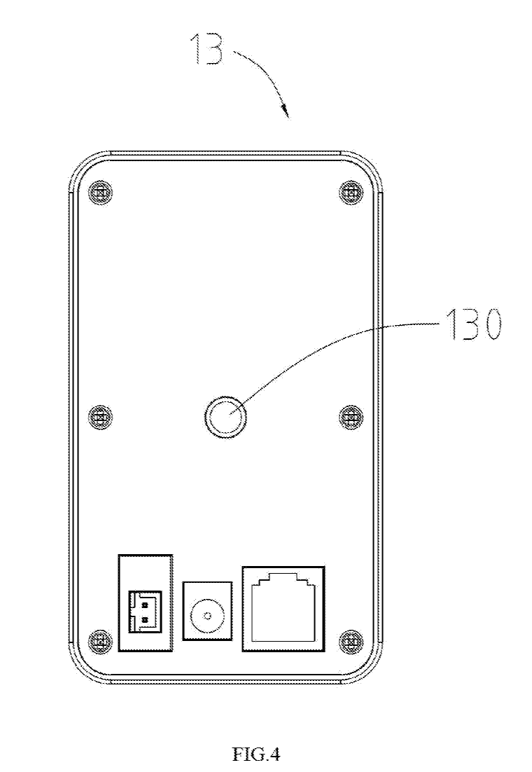

Referring to FIGS. 2-4, the intelligent monitoring device 10 includes a housing 12, a first PCB 14, and a second PCB 16. The housing 12 includes a first cover 17 defining a first hole 170. The first PCB 14 is mounted to the housing 12 and defines a second hole 140 corresponding to the first hole 110. The second PCB 16 is connected to the first PCB 12 and includes the image capturing module 11. The image capturing module 11 extends through the first hole 170 and the second hole 140 to collect the multi-media information of the garage door.

In one embodiment, the image capturing module 11 includes a double optical filter 110 and a HD lens 112 mounted to the double optical filter 110.

The housing 12 also includes a second cover 13 and a frame 15 to fix the first cover 17 and the second cover 13.

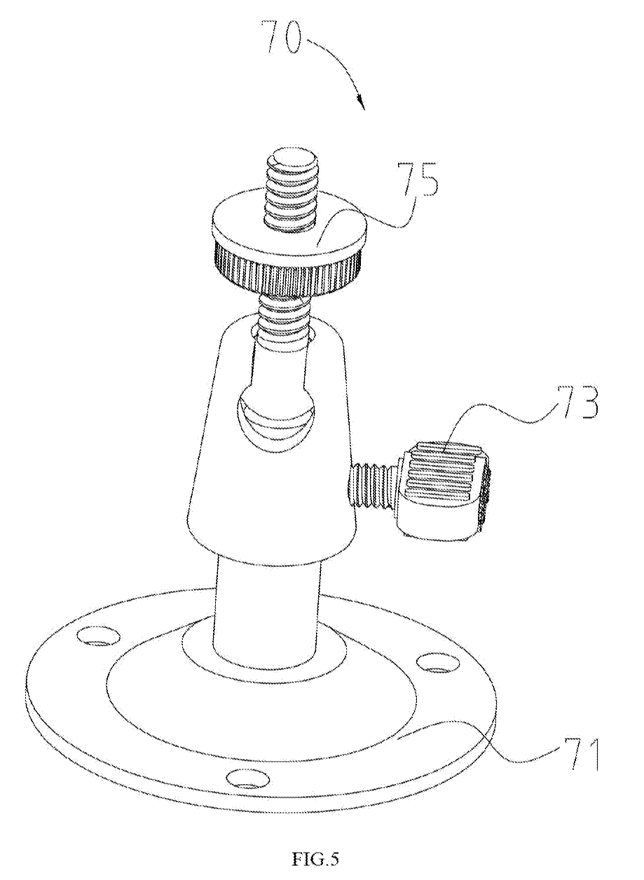

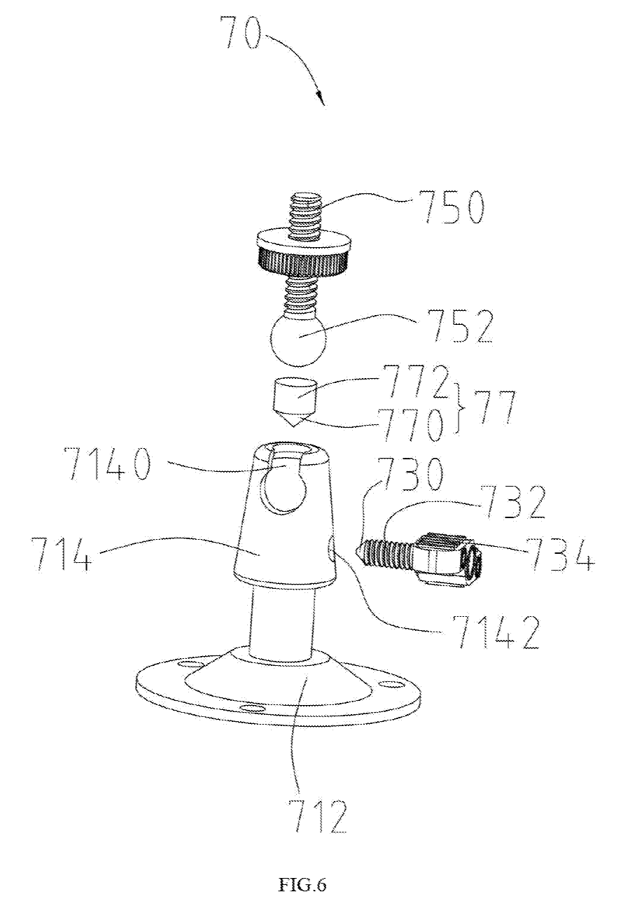

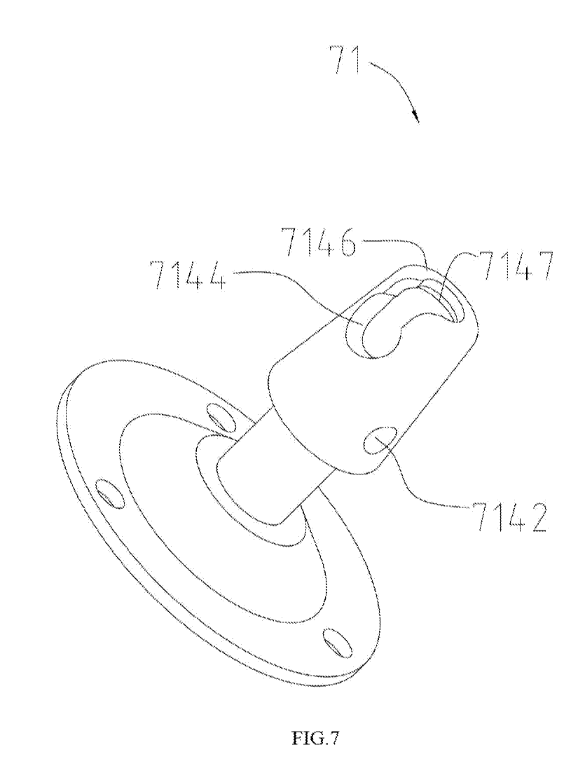

Referring to FIGS. 2-7, the intelligent monitoring system 100 further includes a supporting device 70 which the intelligent monitoring device 10 is mounted to a predetermined position via.

The supporting device 70 includes a fixing member 71, a button member 73, a movable member 75, and a supporting member 77. The fixing member 71 includes a base 712 for supporting the supporting device 70, and a connecting pole 714 defining a receiving groove 7140 located in a centra thereof and a first hole 7142 located a side thereof and in communication with the receiving groove 7140. The button member 73 is rotatably received in the first hole 7142. The movable member 73 is rotatably mounted to the connecting pole 714. The intelligent monitoring device 10 is mounted to the movable ember 73 and may rotate relative to the supporting device 70. The supporting member 77 is received in the receiving groove 7140. The button member 73 abuts against the supporting member 77 to prevent the movable member 75 from accidentally disengaging from the fixing member 71.

In one embodiment, the intelligent monitoring device 10 may rotate 360 degrees relative to the supporting device 70, so that the intelligent monitoring device 10 can collect the multi-media information of the garage door in a range of 360 degrees.

The second cover 13 defines a receiving hole 130, and the movable member 75 includes a first screw rod 750. The first screw rod 750 is mounted in the receiving hole 130 to engage the intelligent monitoring device 10 with the supporting device 70.

In one embodiment, the receiving hole 130 is a threaded hole.

The movable member 75 includes a spherical receiving portion 752 is rotatably received in the receiving groove 7140. The receiving portion 752 may rotate 360 degrees relative to the connecting pole 714.

The connecting pole 714 defines a first groove 7144 in communication with the receiving groove 7140 to facilitate the receiving portion 752 to be received in the receiving groove 7140 via the first groove 7144.

The connecting pole 714 includes an end portion 7146 defining a second groove 7147 in communication with the receiving groove 7140. A diameter of the second groove 7147 is less than that of the receiving groove 7140 to prevent the receiving portion 752 from accidentally disengaging from the connecting pole 714.

The supporting member 77 includes a tapered first contacting portion 770, and the button member 73 includes a tapered second contacting portion 730 abutting against the first contacting portion 770 to prevent the receiving portion 752 from accidentally disengaging from the connecting pole 714 via the first groove 7144.

The supporting member 77 includes a cylindrical supporting portion 772 extending from an end of the first contacting portion 770. The supporting portion 772 supports the receiving portion 752 to prevent the receiving portion 752 from accidentally disengaging from the connecting pole 714 via the first groove 7144 when the second contacting portion 730 abuts against the first contacting portion 770.

The button member 73 includes a second screw rod 732 and a handle 734. The second contacting portion 730 is located at a distal end of the second screw rod 732, and the handle 734 is located at another end of the second screw rod 732.

The handle 734 includes a plurality of ribs formed on a surface thereof, thereby facilitating to rotate the handle 734.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An intelligent monitoring system, comprising:
an intelligent monitoring device comprising an image capturing module and a first communicating module, wherein the image capturing module is used for collecting a multi-media information and transmitting the multi-media information to the first communicating module, and wherein the multi-media information comprises a first multi-media information when a garage door is in an open state and a second multi-media information when the garage door is in a closing state;
a mobile terminal comprising a second communicating module, a displaying module, and a transmitting module, the second communicating module receiving the multi-media information from the first communicating module and sending the multi-media information to the displaying module, wherein a user determines whether the garage door is in the open state or the closing state according to the multi-media information displayed by the displaying module, and sends an instruction information via the transmitting module; and
a garage door device comprising a third communicating module, a controlling module, and a driving module, the third communicating module receiving the instruction information and sending the instruction information to the controlling module, the controlling module distinguishing the instruction information and sending a controlling signal to the driving module, the driving module driving a motor connected to the garage door according to the controlling signal to open the garage door or close the garage door.

2. The intelligent monitoring system of claim 1, wherein the intelligent monitoring device comprising:
a housing comprising a first cover defining a first hole;
a first PCB mounted to the housing, the first PCB defining a second hole corresponding to the first hole; and
a second PCB connected to the first PCB and comprising the image capturing module, the image capturing module extending through the first hole and the second hole.
